(19) United States
(12) Patent Application Publication
(10) Pub. No.: US 2017/0012411 A1
(43) Pub. Date: Jan. 12, 2017

(54) GAS APPLIANCE, MODULAR CONTROL DEVICE THEREOF, AND MANUFACTURING METHOD OF THE MODULAR CONTROL DEVICE

(71) Applicant: GRAND MATE CO., LTD., Taichung City (TW)

(72) Inventors: CHUNG-CHIN HUANG, Taichung City (TW); CHIN-YING HUANG, Taichung City (TW); HSIN-MING HUANG, Taichung City (TW); HSING-HSIUNG HUANG, Taichung City (TW); YEN-JEN YEH, Taichung City (TW); KUAN-CHOU LIN, Taichung City (TW)

(21) Appl. No.: 14/795,224

(22) Filed: Jul. 9, 2015

(51) Int. Cl. H01T 15/00; F23N 5/24; F23N 1/02; H01T 21/00

(52) U.S. Cl. CPC H01T 15/00; H01T 21/00; F23N 5/242; F23N 1/022

(57) ABSTRACT

A gas appliance includes a burning device, an igniting assembly, at least one additional device, and a modular control device. A manufacturing method of the modular control device includes steps below. First, provide a main circuit module which controls the igniting assembly. Second, provide a plurality of additional circuit modules, wherein at least one of the additional circuit modules corresponds to the at least one additional device. Each of the additional circuit modules is detachably connected to the main circuit module. Finally, select at least one of the additional circuit modules which corresponds to the at least one additional device, and connect the additional circuit modules to the main circuit module. Thus, the main circuit module and the selected at least one additional circuit module constitute the modular control device to satisfy a specific kind of gas appliance. Whereby, the manufacturing method lowers the inventory pressure of the control devices.

### BACKGROUND OF THE INVENTION

1. Technical Field

The present invention relates generally to a gas appliance, and more particularly to a gas appliance including a modular control device, and a manufacturing method of the modular control device.

2. Description of Related Art

A conventional gas appliance consists of basic devices including a burning device, a solenoid valve, and an igniting device. The burning device burns gas, the solenoid valve is controllable to supply or cut off the gas to the burning device, and the igniting device is controllable to ignite the gas in the burning device. Some gas appliances further consist of additional devices including, take a water heater for example, a temperature sensor, a flow sensor, and a gas valve. For fireplaces, the additional devices may include a fan and a lamp. In addition, a control device is required to connect the basic devices and the additional devices in such gas appliances.

Various kinds of gas appliances can be found in the market, and additional devices may be different in each kind of gas appliances, a manufacturer therefore has to make various kinds of control devices for different kinds of gas appliances. In current industry, after receiving an order for one kind of gas appliances, the manufacturer has to select the corresponding control device out of the various kinds. Hence, other kinds of control devices may be left unused for a period of time, which causes inventory pressure for the manufacturer.

### BRIEF SUMMARY OF THE INVENTION

In view of the above, the primary objective of the present invention is to provide a gas appliance, a modular control device thereof, and a manufacturing method of the modular control device, which effectively lower inventory pressure of the control devices to gas appliance manufacturers.

The present invention provides a manufacturing method of a modular control device, which is applied to one of a plurality of different gas appliances. Each of the plurality of gas appliances includes a burning device and an igniting assembly. The burning device burns gas. The igniting assembly is controllable to supply or cut off the gas to the burning device, and to ignite the gas in the burning device. One of the plurality of gas appliances further includes at least one first additional device, while another one of a plurality of gas appliances further includes at least one second additional device. The manufacturing method includes that provide a main circuit module, provide a plurality of additional circuit modules, select one of the plurality of gas appliances, select at least one of the plurality of additional circuit modules, and connect the plurality of additional circuit modules to the main circuit module. The main circuit module controls the igniting assembly. The plurality of additional circuit modules respectively correspond to the at least one first additional device and the at least one second additional device. Each of the plurality of additional circuit modules is detachably connected to the main circuit module. The plurality of additional circuit modules correspond to the selected gas appliance. Whereby, the main circuit module and the at least one additional circuit module which is connected to the main circuit module constitute the modular control device of the selected gas appliance.

The present invention further provides a modular control device which controls a gas appliance, wherein the gas appliance includes a burning device, an igniting assembly, and at least one additional device. The burning device burns gas. The igniting assembly is controllable to supply or cut off the gas to the burning device, and to ignite the gas in the burning device. The modular control device includes a main circuit module and at least one additional circuit module. The main circuit module is electrically connected to the igniting assembly to control the igniting assembly. The at least one additional circuit module is detachably connected to the main circuit module, and is electrically connected to the at least one additional device. Whereby, the main circuit module controls the at least one additional device, and receives an electrical signal from the at least one additional device through the at least one additional circuit module.

The present invention further provides a gas appliance, which including a burning device, an igniting assembly, a modular control device, and at least one additional device. The burning device burns gas. The igniting assembly is controllable to supply or cut off the gas to the burning device, and to ignite the gas in the burning device. The modular control device includes a main circuit module and an additional circuit module, wherein the main circuit module is electrically connected to the igniting assembly to control the igniting assembly. The additional circuit module is detachably connected to the main circuit module. The at least one additional device is electrically connected to the additional circuit module. The main circuit module controls the at least one additional device, and receives an electrical signal from the at least one additional device through the additional circuit module.

The modular control device of the present invention may be adopted in different kinds of the gas appliances, for connecting the different additional circuit modules to the main circuit module. Therefore, compare with the conventional manufacturing method of gas appliances, the manufacturing method of the present invention may effectively lower inventory pressure of the control devices to gas appliance manufacturers.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of a preferred embodiment of the present invention, showing the first water heater to which the manufacturing method is applied;

FIG. 2 is a schematic diagram of the preferred embodiment of the present invention, showing the second water heater to which the manufacturing method is applied;

FIG. 3 is a schematic diagram of the preferred embodiment of the present invention, showing the fireplace to which the manufacturing method is applied; and

FIG. 4 is a schematic diagram of the modular control device of the preferred embodiment of the present invention.

### DETAILED DESCRIPTION OF THE INVENTION

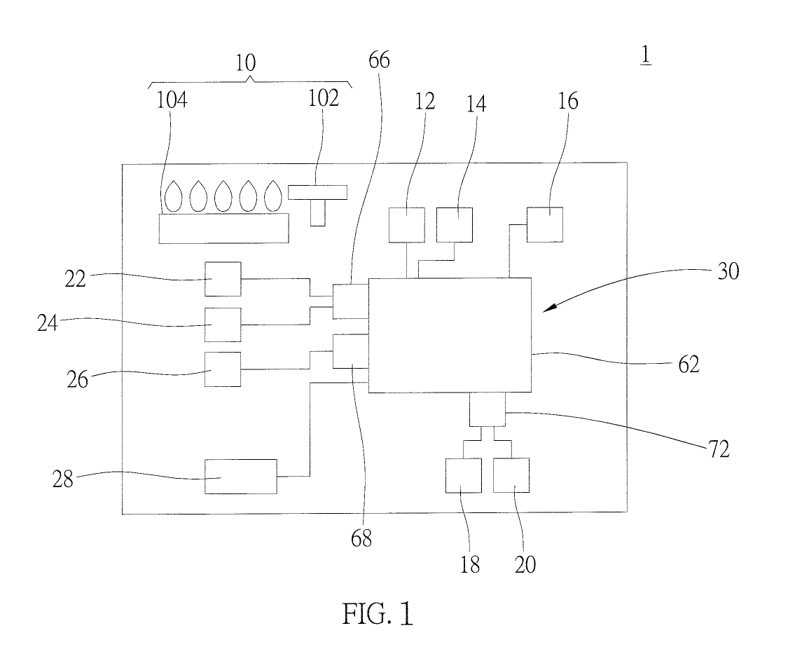

As shown in FIG. 1 to FIG. 3, gas appliances to which a manufacturing method of a modular control device of a preferred embodiment is applied in the present invention are a first water heater 1, a second water heater 2, and a fireplace 3 respectively.

The first water heater 1 includes an igniting assembly and a burning device 10, wherein the igniting assembly includes a safety solenoid valve 12, a main solenoid valve 14, and an igniting device 16. The burning device 10 includes a safety burner 102 and a main burner 104. The safety solenoid valve 12 is controllable to supply or cut off the gas to the safety burner 102; the main solenoid valve 14 is controllable to supply or cut off the gas to the main burner 104. The igniting device 16 is controllable to generate a pilot light in the safety burner 102 to burn the gas in the main burner 104.

The first water heater 1 further includes a plurality of additional devices, including a gas valve 18, a blower 20, a first temperature sensor 22, a second temperature sensor 24, and a flow sensor 26. The gas valve 18 and the blower 20 are connected to the main burner 104. The gas valve 18 is controllable to regulate a gas flow supplied to the main burner 104; the blower 20 is controllable to adjust an amount of air supplied to the main burner 104. In addition, the first water heater 1 includes a pipe (not shown); the first temperature sensor 22 and the second temperature sensor 24 respectively sense an inflow temperature and an outflow temperature in the pipe; the flow sensor 26 senses a water flow in the pipe. Moreover, the first water heater 1 further includes a control panel 28, wherein users may set up the outflow temperature of the first water heater 1 through the control panel 28.

The structure of the second water heater 2 is similar to the first water heater 1. In comparison to the first water heater 1, the second water heater 2 further includes other additional devices, including a thermoelectric conversion module 32 and a remote control device. In the second water heater 2, the thermoelectric conversion module 32 is a thermopile, and the remote control devise is a remote control 34. The thermopile is heated by the main burner 104 to generate electricity. Users may set up an outflow temperature of the second water heater 2 through the remote control 34, which correspondingly emits wireless signals.

The structure of the fireplace 3 is similar to the second water heater 2. The fireplace 3 also includes a burning device 38, an igniting assembly, a gas valve 46, and a blower 48, wherein the igniting assembly also includes a safety solenoid valve 40, a main solenoid valve 42, and an igniting device 44, as the second water heater 2. However, the fireplace 3 further includes other additional devices, including a temperature sensor 50, a fan 52, and a light source 54. The temperature sensor 50 senses a temperature of an indoor space where the fireplace 3 is installed. The fan 52 spreads a thermal flow which is generated by the burning device 38 to the indoor space. In addition, the fireplace 3 includes a control panel 56 and a remote control devise, which is a remote control 58. The control panel 56 and the remote control 58 may be used by users to turn on and turn off the fireplace 3, to regulate a fire power and a rotational speed of the fan 52, as well as to adjust the intensity of light from the light source 54.

Components of each of the aforementioned gas appliances are conventional, and not the focus of the present invention, thus the components are not described in detail herein. In addition, the additional devices in the gas appliances are defined as at least one first additional device and at least one second additional device for explanatory purpose. More specifically, for each gas appliance, the additional device(s) included in the referred gas appliance is defined as the at least one first additional device thereof; on the other hand, the at least one second additional device thereof refers to those additional devices which can be seen in other gas appliances, but not included in the referred gas appliance.

By such definition, for the first water heater 1, the at least one first additional device includes the gas valve 18, the blower 20, the first temperature sensor 22, the second temperature sensor 24, and the flow sensor 26; the at least one second additional device includes the thermoelectric conversion module 32 and the remote control 34 which are possessed by the second water heater 2, and the fan 52 and the light source 54 which are possessed by the fireplace 3.

Similarly, for the second water heater 2, the at least one first additional device includes the gas valve 18, the blower 20, the first temperature sensor 22, the second temperature sensor 24, the flow sensor 26, and the thermoelectric conversion module 32; the at least one second additional device includes the fan 52 and the light source 54 which are possessed by the fireplace 3.

As for the fireplace 3, the at least one first additional device includes the gas valve 46, the blower 48, the temperature sensor 50, the fan 52, and the light source 54; the at least one second additional device includes the thermoelectric conversion module 32 which is possessed by the second water heater 2.

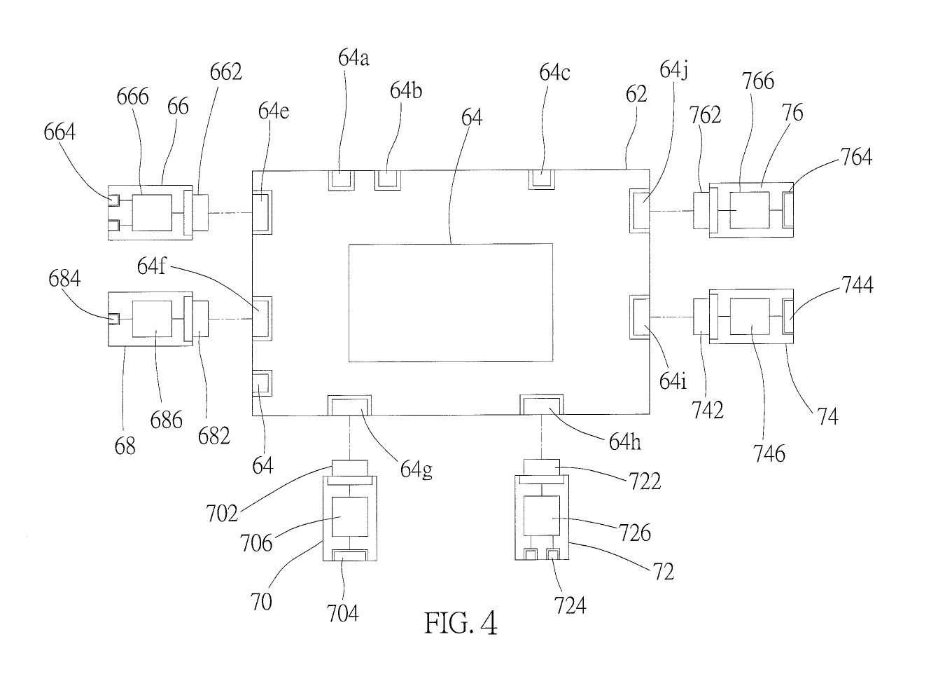

The manufacturing methods of the modular control devices of the gas appliances are described below. As shown in FIG. 4, a main circuit module 62 and a plurality of additional circuit modules 66-76 are provided for different kinds of gas appliances first. The main circuit module 62 includes a control circuit 64 and a plurality of first ports 64a-64j, wherein the plurality of first ports 64a-64j are electrically connected to the control circuit 64. The safety solenoid valve 12, 40, the main solenoid valve 14, 42, the igniting device 16, 44, and the control panel 28, 56 of the gas appliances are respectively connected to the first ports 64a-64d.

The control circuit 64 controls the igniting device 16, 44 to generate the pilot light in the safety burner 102, and opens the safety solenoid valve 12, 40. After the pilot light is generated in the safety burner 102, the control circuit 64 opens the main solenoid valve 14, 42 to output the gas to the main burner 104 to be ignited by the pilot light and to be burned therein.

Each of the plurality of additional circuit modules 66-76 is correspondingly connected to one of the first ports 64e-64j in a detachable way. In addition, each of the plurality of additional circuit modules 66-76 is connected to at least one additional device. The main circuit module 62 controls the at least one additional device, or receives an electrical signal from the additional device through the plurality of additional circuit modules 66-76.

The additional circuit module 66 includes a connecting interface 662, two second ports 664, and a conversion circuit 666. The connecting interface 662 is connected to the first port 64e of the main circuit module 62. Each of the two second ports 664 is connected to the first temperature sensor 22, the second temperature sensor 24, or the temperature sensor 50. The conversion circuit 666 converts an analog signal which is output from the temperature sensor 22, 24, 50 into a digital signal, and inputs the digital signal to the connecting interface 662 for the control circuit 64.

The additional circuit module 68 includes a connecting interface 682, a second port 684, and a conversion circuit 686. The connecting interface 682 is connected to the first port 64f of the main circuit module 62. The second port 684 is connected to the flow sensor 26. The conversion circuit 686 amplifies a detection signal which is output from the flow sensor 26, and inputs the amplified detection signal to the connecting interface 682 for the control circuit 64.

The additional circuit module 70 is connected to the remote control 34, 58 for bidirectional transmission. The additional circuit module 70 includes a connecting interface 702, a transceiver circuit 704, and a conversion circuit 706. The connecting interface 702 is connected to the first port 64g of the main circuit module 62. The transceiver circuit 704 receives a wireless signal which is output from the remote control 34, 58. The conversion circuit 706 converts the wireless signal into a digital signal, and inputs the digital signal to the connecting interface 702. On the other hand, the conversion circuit 706 converts a digital signal which is output from the main circuit module 62 into a wireless signal; the transceiver circuit 704 transmits the wireless signal to the remote control 34, 58. The aforementioned wireless signal may be a RF, Wi-Fi, or Bluetooth signal. Whereby, the wireless signal transmitted by the remote control 34, 58 to the main circuit module 62 contains a control instruction for controlling the solenoid valve 12, 14, 40, 42, the igniting device 16, 44, and other additional devices. On the other hand, the control circuit 64 of the main circuit module 62 encapsulates the statuses of other additional devices such as the solenoid valve 12, 14, 40, 42, and the igniting device 16, 44 into digital signals. The remote control 34, 58 receives the digital signals through the additional circuit module 70 to accordingly perform a subsequent operation (showing the statuses, for example).

The additional circuit module 72 includes a connecting interface 722, two second ports 724, and a conversion circuit 726. The connecting interface 722 is connected to the first port 64h of the main circuit module 62. The two second ports 724 are respectively connected to the gas valve 18, 46 and the blower 20, 48. The conversion circuit 726 has corresponding information of air-fuel ratio therein. The control circuit 64 transmits a fire adjusting signal to the first port 64h. The conversion circuit 726 receives the fire adjusting signal from the connecting interface 722, and inputs a corresponding control signal to the gas valve 18, 46 and the blower 20, 48 according to the corresponding information of air-fuel ratio. Whereby, the gas valve 18, 46 and the blower 20, 48 are controllable to supply a specific ratio of the gas to the air to the main burner 104 for increasing the burning efficiency.

The additional circuit module 74 includes a connecting interface 742, a second port 744, and a regulator circuit 746. The connecting interface 742 is connected to the first port 64i of the main circuit module 62. The second port 744 is connected to the thermoelectric conversion module 32. The regulator circuit 746 stabilizes or steps up a voltage which is generated by the thermoelectric conversion module 32, and inputs the voltage to the connecting interface 742 as power required by the main circuit module 62.

The additional circuit module 76 includes a connecting interface 762, two second ports 764, and a conversion circuit 766. The connecting interface 762 is connected to the first port 64j of the main circuit module 62. The two second ports 764 are respectively connected to the fan 52 and the light source 54. The control circuit 64 transmits two control signals to the first port 64j. The conversion circuit 766 receives the control signals from the connecting interface 762, and converts the control signals into digital signals to control the fan 52 and the light source 54.

Therefore, the manufacturers of the gas appliances can select the corresponding additional circuit modules 66-76 for a specific gas appliance. By connecting each of the selected corresponding additional circuit modules 66-76 to one of the first port 64e-64j, the main circuit module 62 and the selected corresponding additional circuit modules 66-76 constitute the modular control device of the specific gas appliance. In this way, the assembling process of this gas appliance is completed after connecting the modular control device to other components of the gas appliance.

For example, as shown in FIG. 1, the modular control device 30 of the first water heater 1 consists of the main circuit module 62 and the additional circuit modules 66, 68, 72, wherein the additional circuit modules 66, 68, 72 are connected to the main circuit module 62.

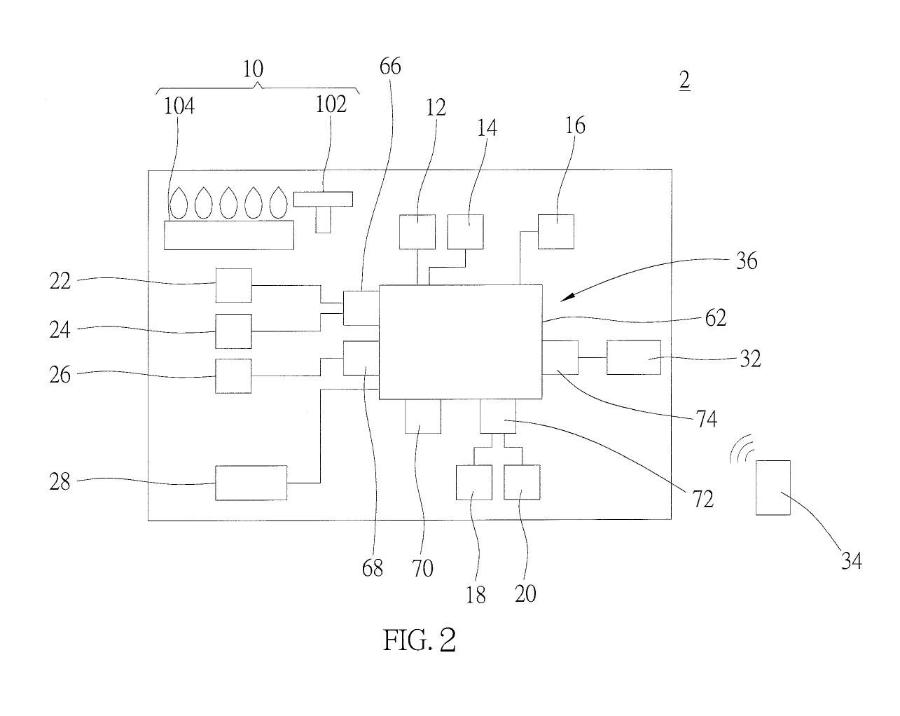

As shown in FIG. 2, the modular control device 36 of the second water heater 2 consists of the main circuit module 62 and the additional circuit modules 66, 68, 72, 74, wherein the additional circuit modules 66, 68, 72, 74 are connected to the main circuit module 62.

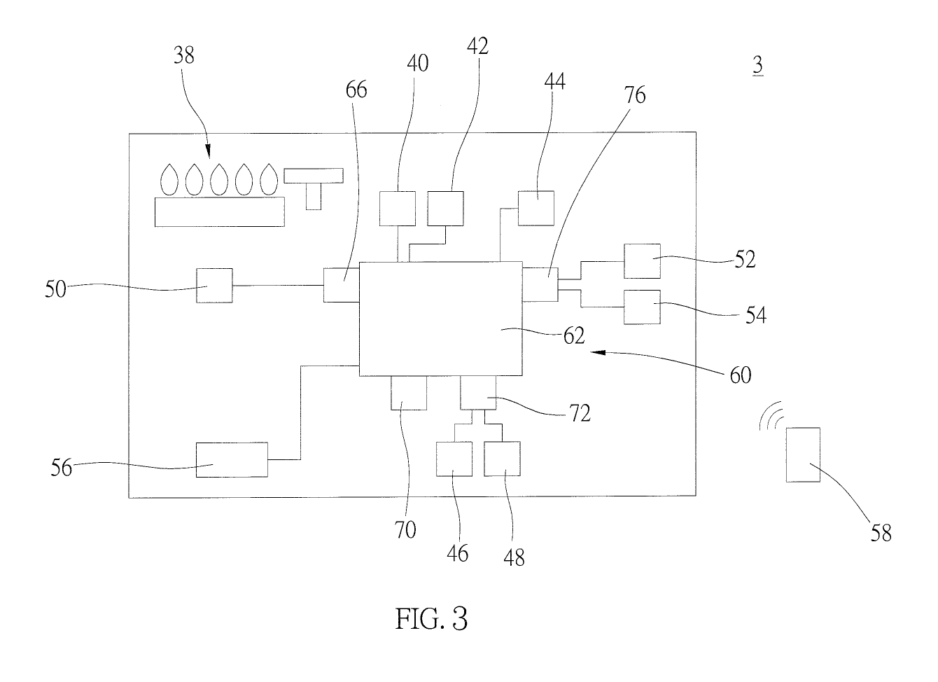

As shown in FIG. 3, the modular control device 60 of the fireplace 3 consists of the main circuit module 62 and the additional circuit modules 66, 70, 72, 76, wherein the additional circuit modules 66, 70, 72, 76 are connected to the main circuit module 62.

In summary, a main circuit module and at least one additional circuit module constitute the modular control device of one of the gas appliances in the present invention. To produce the modular control device for a specific gas appliance, the manufacturer may select the corresponding additional circuit modules to connect to the main circuit module. In other words, different additional circuit modules which are connected to the main circuit module are applied to different kinds of gas appliances. Whereby, in comparison to the conventional manufacturing method of the gas appliances, the manufacturing method of the present invention relatively lowers the inventory pressure of the control devices, for there is no need to produce specific control devices for all kinds of gas appliances.

It must be pointed out that the embodiments described above are only some preferred embodiments of the present invention. All equivalent structures and methods which employ the concepts disclosed in this specification and the appended claims should fall within the scope of the present invention.

What is claimed is:

1. A manufacturing method of a modular control device, which is applied to one of a plurality of different gas appliances, wherein each of the plurality of gas appliances comprises a burning device and an igniting assembly; the burning device burns gas, and the igniting assembly is controllable to supply or cut off the gas to the burning device, as well as to ignite the gas in the burning device; one of the plurality of gas appliances further comprises at least one first additional device, while another one of a plurality of gas appliances further comprises at least one second additional device; comprising :
providing a main circuit module which controls the igniting assembly;
providing a plurality of additional circuit modules which respectively correspond to the at least one first additional device and the at least one second additional device; each of the plurality of additional circuit modules is detachably connected to the main circuit module;
selecting one of the plurality of gas appliances, and selecting at least one of the plurality of additional circuit modules corresponding to the selected gas appliance; and
connecting the selected at least one additional circuit module to the main circuit module;
whereby, the main circuit module and the at least one additional circuit module which is connected to the main circuit module constitute the modular control device of the selected gas appliance.

2. The manufacturing method of claim 1, wherein the main circuit module comprises a plurality of ports; each of the plurality of additional circuit modules comprises a connecting interface for connecting to one of the ports.

3. A modular control device which controls a gas appliance, wherein the gas appliance comprises a burning device, an igniting assembly, and at least one additional device; the burning device burns gas, and the igniting assembly is controllable to supply or cut off the gas to the burning device, as well as to ignite the gas in the burning device; comprising:
a main circuit module electrically connected to the igniting assembly to control the igniting assembly; and
at least one additional circuit module detachably connected to the main circuit module, as well as electrically connected to the at least one additional device;
whereby, the main circuit module controls the at least one additional device, and receives an electrical signal from the at least one additional device through the at least one additional circuit module.

4. The modular control device of claim 3, wherein the at least one additional device comprises multiple additional devices; the at least one additional circuit module comprises multiple additional circuit modules; the main circuit module comprises a plurality of ports; each of the at least one additional circuit module comprises a connecting interface connected to one of the plurality of ports.

5. The modular control device of claim 3, wherein the at least one additional device is a remote control device; the main circuit module comprises a port; the at least one additional circuit module comprises a connecting interface, a transceiver circuit, and a conversion circuit, wherein the connecting interface is connected to the port; the transceiver circuit bidirectionally transmits wireless signals to and from the remote control device; the conversion circuit is electrically connected to the connecting interface and the transceiver circuit; the transceiver circuit receives a wireless signal from the remote control device; the conversion circuit converts the wireless signal into an electrical signal, and inputs the electrical signal to the main circuit module; furthermore, an electrical signal which is output from the main circuit module is transmitted to the conversion circuit through the port and the connecting interface, and the conversion circuit converts the electrical signal into a wireless signal.

6. A gas appliance, comprising:
a burning device which burns gas;
an igniting assembly controllable to supply or cut off the gas to the burning device, as well as to ignite the gas in the burning device;
a modular control device comprising a main circuit module and an additional circuit module, wherein the main circuit module is electrically connected to the igniting assembly to control the igniting assembly; the additional circuit module is detachably connected to the main circuit module ;and
at least one additional device electrically connected to the additional circuit module;
wherein the main circuit module controls the at least one additional device, and receives an electrical signal from the at least one additional device through the additional circuit module.

7. The gas appliance of claim 6, wherein the at least one additional device comprises multiple additional devices; the additional devices comprise a blower and a gas valve, which are connected to the burning device; the blower is controllable to adjust an amount of air supplied to the burning device, and the gas valve is controllable to regulate a gas flow supplied to the burning device; the blower and the gas valve are electrically connected to the additional circuit module, wherein the additional circuit module has corresponding information of air-fuel ratio therein; the main circuit module transmits a fire adjusting signal to the additional circuit module to control the blower and the gas valve according to the corresponding information of air-fuel ratio.

8. The gas appliance of claim 6, wherein the at least one additional device comprises a remote control device; the main circuit module comprises a port; the additional circuit module comprises a connecting interface, a transceiver circuit, and a conversion circuit, wherein the connecting interface is connected to the port; the transceiver circuit bidirectionally transmits wireless signals to and from the remote control device; the conversion circuit is electrically connected to the connecting interface and the transceiver circuit; the transceiver circuit receives a wireless signal from the remote control device; the conversion circuit converts the wireless signal into an electrical signal, and inputs the electrical signal to the main circuit module; furthermore, an electrical signal which is output from the main circuit module is transmitted to the conversion circuit through the port and the connecting interface, and the conversion circuit converts the electrical signal into a wireless signal.
